(19) United States
(12) Patent Application Publication
(10) Pub. No.: US 2007/0119858 A1
(43) Pub. Date: May 31, 2007

(54) MULTIFUNCTIONAL DISPENSER

(76) Inventor: Ihab Ayoub, Houston, TX (US)

Correspondence Address: IHAB (AHAB) AYOUB, 2210 WEST DALLAS, NO. 1632, HOUSTON, TX, 77019, US

(21) Appl. No.: 11/564,289

(22) Filed: Nov. 28, 2006

Related U.S. Application Data
(60) Provisional application No. 60/597,422, filed on Nov. 29, 2005.

(51) Int. Cl. G07F 11/00

(52) U.S. Cl. 221/2

(57) ABSTRACT

A multifunctional dispenser is disclosed, having at least one electronic component integrated therein. The multifunctional dispenser includes a cavity configured to accommodate at least some portion of a predetermined dispensing container configuration, such as a tissue box. Electronic components integrated into, and/or operatively connectable to, the multifunctional dispenser may include a clock, an alarm, a radio, a television, a telephone, a computer, a portable storage device (e.g., mp3 player) and others. Sensors may be incorporated into the multifunctional dispenser to sense a quantity of items dispensed and/or remaining. The electronic components may be remotely operable. The multifunctional dispenser may also include a wireless transmitter and/or receiver for communicating with external electronic devices. The multifunctional dispenser may also be configured for the reversible connection of a predetermined multimedia medium such as a CD, DVD and/or flash memory device. One variation of the multifunctional dispenser may be utilized as a baby monitor, and capture and/or transmit audio, still pictures, and/or video to a remote electronic device for monitoring from the remote location.

### CROSS-REFERENCE TO RELATED APPLICATIONS

This application claims priority to U.S. Provisional Patent Application No. 60/597,422, “TISSUE BOX HOLDER” filed Nov. 29, 2005, and hereby incorporated by reference.

### BACKGROUND OF INVENTION

1. Field of the Invention

The invention relates generally to a multifunctional dispenser having at least one electronic component.

2. Background Art

Holders for tissue boxes have traditionally been shaped to match a particular size of tissue box and usually comprise some form of box having an opening in a bottom surface thereof for entry and egress of a tissue box, and an opening in a top surface for the dispensing of tissues. Although tissue box holders come in a variety of decorative styles they have typically been limited to a decorative function in addition to their role as holders for tissue boxes. Because tissue box holders are often placed on surfaces, such as nightstands and tables, upon which are often disposed other devices such as clocks, radios, video displays, and other items, there is a need for a tissue box having a combined functionality to optimize the use of the relatively limited space available on the surfaces on which they are often disposed.

### SUMMARY OF INVENTION

In one embodiment, the invention relates to a multifunctional dispenser having a cavity for housing at least a portion of a predetermined dispensing container, and an integrated display and/or other electronic components. Such electronic components may be integrated into the multifunctional dispenser and/or operatively connectible thereto. One or more connectors may be included for operatively connecting to an input and/or output of external electronic devices. One or more controls may be disposed on a surface of the multifunctional dispenser and the components thereof may be remotely controllable as well. Electronic devices may be of any type known in the art and include, but are not limited to, a clock, alarm, television, telephone, light, computer, removable media reader, camera, audio recorder, and any other electronic devices known in the art. The multifunctional dispenser may also include one or more integrated lights.

In one embodiment, the invention comprises a method for manufacturing a multifunctional dispenser having a cavity for housing dispensible items, and at least one integrated electronic component.

In one embodiment, the invention comprises a multifunctional dispenser having at lease one electronic component for capturing still images, video, and/or audio. The multifunctional dispenser may also include and/or be operatively connectible to a device for storing and/or displaying the captured media.

Other aspects and advantages of the invention will be apparent from the following description and the appended claims.

### BRIEF DESCRIPTION OF DRAWINGS

FIG. 1 shows a multifunctional dispenser, incorporating a clock according to one embodiment of the invention.

FIG. 2 shows a multifunctional dispenser with a display according to one embodiment of the invention.

FIG. 3 shows a multifunctional dispenser with a display, microphone, and camera according to one embodiment of the invention.

FIG. 4 shows a multifunctional dispenser with a display and a light, according to one embodiment of the invention.

FIG. 5 shows one embodiment of a multifunctional dispenser, with a dispensing container partially disposed within a cavity thereof.

### DETAILED DESCRIPTION

As used herein, a “multifunctional dispenser” is an apparatus configured to at least partially accommodate containers housing dispensible items (“dispensing container”), within a cavity thereof, while having at least one additional function.

Containers which may be at least partially housed within a multifunctional dispenser include those for dispensing tissues or similar items such as towels, moist towelettes, diaper wipes, gloves, adhesive tabs (e.g., Post-It™ Notes), and/or any other similarly dispensed items.

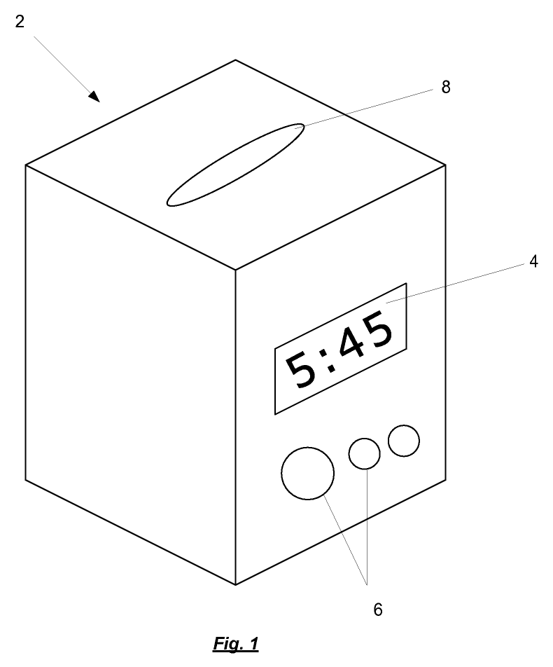

As shown in FIG. 1, in one embodiment, the invention comprises a multifunctional dispenser 2 having a display 4. One or more controls 6 may also be disposed at various locations on any desired surface of the multifunctional dispenser 2. The controls 6 may be disposed on the same surface as the display 4, and/or any other surface of the multifunctional dispenser 2. The display 4 may display information relating to a clock, a radio, a television, and/or any other electronic components disposed in the multifunctional dispenser 2 or operatively connected thereto. The display 4 may be disposed on any surface of the multifunctional dispenser 2. Furthermore, multiple displays 4 may be disposed on one or more surfaces of the multifunctional dispenser 2.

The display 4 may be of any type known in the art capable of displaying a desired type of information and/or media.

In one embodiment, the multifunctional dispenser 2 is configured to operatively connect to removable media. The removable media may be of any type known in the art, including but not limited to CDs, DVDs, flash memory cards, and/or any other medium for the storage of multimedia content or other data, and the multifunctional dispenser 2 may be configured to permit reversible insertion of, and/or an operative connection to, any one or more of such removable media. In one embodiment, such an operative connection comprises a wireless connection, such as WiFi, Bluetooth, etc., and the multifunctional dispenser 2 will include components (e.g., a wireless modem) for making such an operative connection. In one embodiment, the multifunctional dispenser 2 is configured to operatively connect to at least one other electronic device. Such an electronic device may provide data (audio, video, etc.) for display on the display 4 of the multifunctional dispenser 2. Such an operative connection may be of any type known in the art. For example, in one embodiment, the multifunctional dispenser 2 may operatively connect (e.g., using a wireless connection) to a device for determining temperature and/or other aspects of the weather, which may be located remotely from the multifunctional dispenser 2. In one embodiment, the multifunctional dispenser 2 may operatively connect to a device worn by an operator, which may provide physiological data to the multifunctional dispenser for use, e.g., with an alarm feature. In such an example, sleep cycles of the operator may be tracked to allow a waking feature to coincide with a predetermined portion of the operator's sleep cycle.

The multifunctional dispenser 2 includes a cavity for the reversible insertion of at least a portion of a dispensing container. The multifunctional dispenser 2 may be of any size and configuration known in the art, and may be sized and/or configured to accommodate a particular size and configuration of dispensing container. The cavity may be reversibly sealed, at least partially, by a movable and/or removable surface. For example, such a movable and/or removable surface may be operatively connected to at least one other surface by a hinge, or may be slideably disposed. Furthermore, the multifunctional dispenser 2 may be operatively connected to a base, such base being detachable to expose the cavity. Although shown in various embodiments as a square or rectangular apparatus, the multifunctional dispenser 2, and the various surfaces thereof, may be of any desired shape, including round and oval configurations.

The multifunctional dispenser 2 includes an opening 8 in a surface thereof for the passage of dispensible items disposed therein. Although embodiments of the invention are described with respect to a tissue box and tissue paper, any similarly dispensed products may also be disposed in the cavity and accessed through the opening 8. In one embodiment, at least a portion of a surface of the multifunctional dispenser 2 is open, detachable or hinged such that a dispensing container may be at least partially inserted into the cavity.

The display 4 and controls 6 may be of any type known in the art. The display 4 and controls 6 may be disposed on any surface of the multifunctional dispenser 2. Any number of displays 4 and/or controls 6 may be disposed at any location in the multifunctional dispenser 2. Individual displays 4 may be configured to display different information from other displays 4 disposed in the multifunctional dispenser 2. For example, one display 4 might be used to display multimedia content, while a second display 4 might be used to display date, time, and/or weather information. Furthermore, the display 4 and controls 6 need not occupy the same surface of the multifunctional dispenser 2. Various functions of the multifunctional dispenser 2 may also be remotely operable.

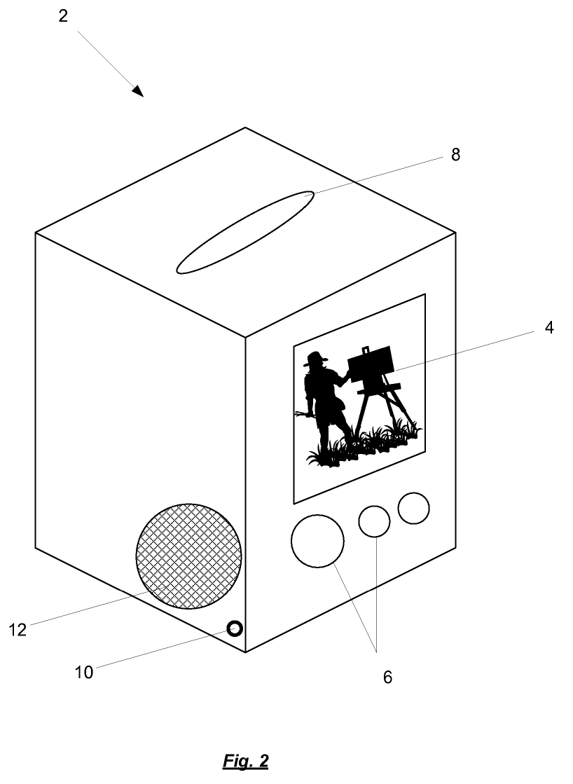

As shown in FIG. 2, in one embodiment, a display 4 is configured to show images, including but not limited to still images and video. In one embodiment, the multifunctional dispenser 2 includes one or more speakers 12. The one or more speakers 12 may be disposed on any surface of the multifunctional dispenser 2 and may be of any type known in the art. In one embodiment, the multifunctional dispenser 2 comprises a television including a tuner and a display. One or more connectors 10 may be included in various embodiments for connecting the multifunctional dispenser 2 to an input and/or output of one or more external devices (not shown) and/or an external power source.

Accordingly, a device such as an mp3 player, computer, and/or television tuner may be operatively connected to the tissue box for the transmission of music, pictures, video, or other data therebetween. Alternatively, such devices, and any other electronic device, may be integrated into the multifunctional dispenser 2.

In one embodiment, the invention comprises a multifunctional dispenser 2 having an analog clock disposed therein. The clock may include an alarm feature.

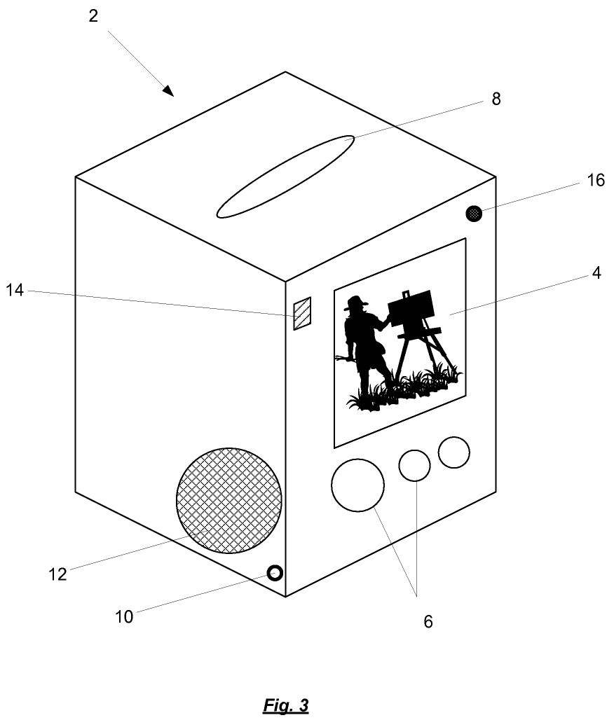

The multifunctional dispenser 2 may also include a mechanism and/or components for capturing and/or recording media such as still pictures, video and/or audio. As shown in the embodiment of FIG. 3, such components may include a microphone 14 and/or camera 16. A display 4 and speaker 12 may also be included in such a configuration. A data storage system may also be integrated into the multifunctional dispenser 2, for storing captured media, and may be configured to operatively connect to one or more external electronic devices for the transmission of data. Alternatively, the multifunctional dispenser 2 may operatively connect to another electronic device for the storage, display, and/or transmittal of media captured by a camera and/or microphone of the multifunctional dispenser 2. For example, the multifunctional dispenser 2 may be used to monitor its environment and transmit relevant data to a remote operatively connected electronic device, which may comprise a second multifunctional dispenser 2. Such embodiments may be utilized as baby monitors, etc.

In one embodiment, the multifunctional dispenser 2 may be configured to wirelessly communicate with one or more external devices. Other external devices, such as a weather detection system, may also be operatively connected to the connector 10 of the multifunctional dispenser. In one embodiment a telephone, which may be configured as a speakerphone, may be integrated into the multifunctional dispenser 2.

Embodiments of the invention may operate on battery power, electrical power, and/or any combination thereof. Furthermore, embodiments of the invention may comprise any material or combination of materials known in the art and may also include decorative features and configurations in addition to those explicitly described herein.

The multifunctional dispenser 2 may have any number and/or configuration of surfaces. In one embodiment, one or more surfaces of the multifunctional dispenser 2 will have a curved or rounded configuration. The overall physical configuration of the multifunctional dispenser 2 according to various embodiments of the invention may be of any type known in the art so long as the configuration includes a cavity configured to accept at least some portion of a predetermined dispensing container, or sufficient to accommodate other objects which may be dispensed therefrom. In one embodiment, the multifunctional dispenser 2 will be configured to be placed on top of a dispensing container such that only a portion of the dispensing container will be disposed within the cavity of the multifunctional dispenser 2.

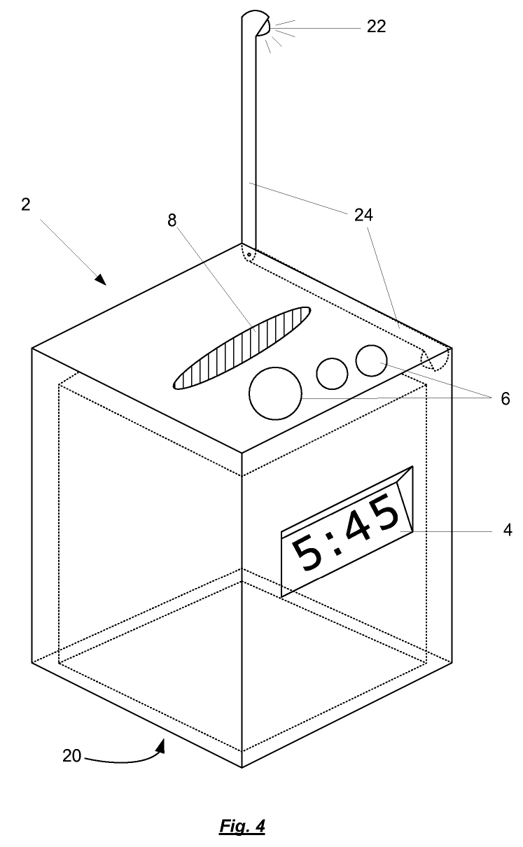

In one embodiment, the multifunctional dispenser 2 may include one or more lights. Such lights may be decorative, and/or functional. For example, in one embodiment, a light may be operatively connected to the multifunctional dispenser 2 and configured to shed light on a nearby location. As shown in FIG. 4, such a configuration may include a light 22 that is movable, or otherwise directable by a user. In one embodiment, the light 22 may be operatively connected to a shaft 24, which may be movable (e.g., rotatable) such that it is inactive in a first position, and activated in a second position. In one embodiment, one or more lights may be integrated into the multifunctional dispenser 2 to provide a diffuse, decorative lighting. In one embodiment, integrated lights may play a role in an alarm feature of the multifunctional dispenser 2, by, for example, activating and/or increasing in brightness in order to wake an individual situated nearby. In one embodiment, the light 22 may be operatively connected to the multifunctional dispenser 2 by means of a shared base (e.g., the light 22 is operatively connected to a base to which the multifunctional dispenser 2 may also operatively connect). Such a base may advantageously connect both the light 22 and multifunctional dispenser 2 to a power source.

As shown in the embodiment of FIG. 4, the cavity 20 of the multifunctional dispenser 2 may be accessible through the bottom of the multifunctional dispenser 2 in a manner similar to traditional tissue box covers, advantageously permitting the placement of the multifunctional dispenser 2 over at least an upper portion of a traditional tissue box, or other dispensing container, in a manner familiar to many potential users.

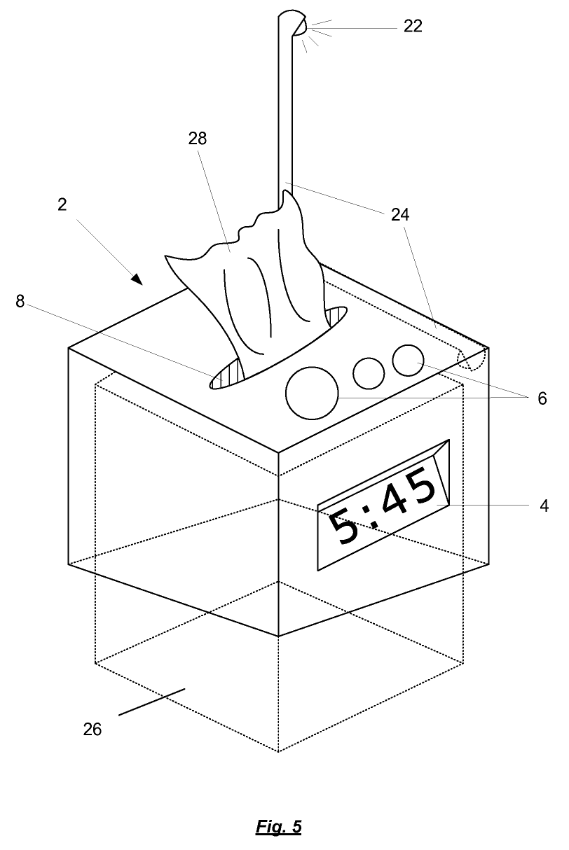

FIG. 5 shows one embodiment of a multifunctional dispenser 2 having a dispensing container 26 partially disposed in a cavity thereof. Dispensible items 28 such as tissues, may be dispensed from the dispensing container 26 through an opening 8 of the multifunctional dispenser 2.

Although the opening 8 is shown as an oval in various embodiments, it may be of any configuration known in the art. Furthermore, the opening 8 need not be disposed in a top surface of the multifunctional dispenser 2, and may be disposed in any desired surface thereof.

Operative connections may be physical, electrical, wireless, and/or of any other type known in the art. In one or more embodiment, multiple types of operative connections may be desirable.

In one embodiment, the invention comprises a method of manufacturing a multifunctional dispenser 2 according to any of the configurations described herein. Such a method comprises operatively connecting one or more electronic components to a housing having at least one cavity for at least partial insertion of a dispensing container, and at least one opening for passage of dispensible items. In one embodiment, the invention comprises a method of using a multifunctional dispenser 2 according to any of the configurations described herein.

In one embodiment, the display of the multifunctional dispenser 2 may display the quantity of dispensible items available for dispensing. One or more sensors may be integrated into the multifunctional dispenser 2 and/or a dispensing container to determine or estimate such quantities. Such an embodiment advantageously provides advance notice of when additional dispensible items may need to be provided.

Advantages of embodiments of a multifunctional dispenser 2 as described herein include a more efficient use of space. For instance, where the multifunctional dispenser includes tissue dispensing capability and a clock feature, it may be configured to require approximately the same space as a standard tissue box, while obviating the need for additional space for placement of a clock. Such advantages are particularly beneficial in areas having limited space, such as desks, night stands, hotel rooms, counter tops, boat cabins, etc. Combining additional features such as radio, television, lights, etc. further increases the advantageous space savings.

While the invention has been described with respect to a limited number of embodiments, those skilled in the art, having benefit of this disclosure, will appreciate that other embodiments can be devised which do not depart from the scope of the invention as disclosed herein. For instance, although many dispensible items are provided with their own container which may be at least partially housed in the multifunctional dispenser, the multifunctional dispenser may also be utilized to directly dispense serially-dispensed items (i.e., items configured such that the removal of one positions a second for dispensing, such as tissues, wipes, etc.) without requiring that such items be housed within a container. Accordingly, the scope of the invention should be limited only by the attached claims.

What is claimed is:

1. A multifunctional dispenser, comprising:
a cavity for reversibly housing at least a portion of a dispensing container therein;
an opening for passage of dispensible items from the dispensing container when the dispensing container is at least partially disposed within the cavity; and
at least one electronic component, selected from a display, a speaker, a microphone, a camera, a light, a clock, a radio, a television, a computer, a telephone, and an alarm.

2. The multifunctional dispenser of claim 1, further comprising at least one component for operatively connecting to a remote electronic device.

3. The multifunctional dispenser of claim 2, wherein the at least one component is configured for a wireless operative connection with the remote electronic device.

4. The multifunctional dispenser of claim 1, further comprising at least one selected from an input jack and an output jack, for operatively connecting an external electronic device.

5. The multifunctional dispenser of claim 1, further comprising at least one sensor for receiving a signal from a remote control device.

6. The multifunctional dispenser of claim 1, further comprising at least one data storage component.

7. The multifunctional dispenser of claim 1, wherein the multifunctional dispenser is configured to reversibly connect to a predetermined type of removable media.

8. The multifunctional dispenser of claim 1, wherein the dispensible items comprise at least one selected from tissues, wipes, gloves, and adhesive tabs.

9. The multifunctional dispenser of claim 1, further comprising a sensor for sensing a quantity of items dispensed.

10. The multifunctional dispenser of claim 9, wherein the sensor is operatively connected to a display for displaying at least one selected from the number of items dispensed, and the number of items remaining to be dispensed.

11. A method for manufacturing a multifunctional dispenser, comprising:
operatively connecting at least one electronic component to an apparatus having a cavity configured to accommodate at least some predetermined portion of a dispensing container; and
disposing at least one opening in a surface of the apparatus, such that dispensible items disposed in the dispensing container may be dispensed through the opening, when the dispensing container is at least partially disposed in the cavity.

12. The method of claim 11, wherein the at least one electronic component is at least one selected from a display, a speaker, a microphone, a camera, a light, a clock, a radio, a television, a computer, a telephone, and an alarm.

13. The method of claim 11, further comprising integrating the at least one electronic component into the apparatus.

14. The method of claim 11, further comprising disposing at least one control in at least one predetermined location on the apparatus.

15. The method of claim 11, further comprising operatively connecting at least one data storage component to the apparatus.

16. The method of claim 11, further comprising configuring a surface of the apparatus to be at least one selected from hinged, removable, and slideable, such that the cavity may be reversibly sealed by the surface.

17. A multifunctional dispenser, comprising:
a cavity accessible through a first opening, for reversibly housing predetermined dispensible items therein;
an second, smaller opening for passage of the dispensible items from within the cavity; and
at least one electronic component, selected from a display, a speaker, a microphone, a camera, a light, a clock, a radio, a television, a computer, a telephone, and an alarm.

18. The multifunctional dispenser of claim 17, further comprising at least one selected from an input jack and an output jack.

19. The multifunctional dispenser of claim 17, further comprising at least one communication component for communicating with a remote electronic device.

20. The multifunctional dispenser of claim 17, further comprising at least one data storage component.
